(19) United States
(12) Patent Application Publication
(10) Pub. No.: US 2006/0049762 A1
(43) Pub. Date: Mar. 9, 2006

(54) Night-vision illumination lamp

(76) Inventor: Mark E. Koch, Farmers Branch, TX (US)

Correspondence Address: Mark E. Koch, 13040 Pennystone Farmers Branch, Farmers Branch, TX, 75244, US

(21) Appl. No.: 10/933,368

(22) Filed: Sep. 3, 2004

(51) Int. Cl. H01J 17/20

(52) U.S. Cl. 313/637

(57) ABSTRACT

Alkali electric discharges have been considered previously for night-vision illuminator applications due to copious near-infrared emissions. However, high-pressure alkali short arc lamps exhibited low brightness, particularly at the cathode tip. The cause of this phenomenon is now recognized and a lamp invented which exhibits a small volume arc of high brightness. This lamp has better beam collimation and focussing characteristics than previously tested alkali lamps.

### BACKGROUND

1. Field of Invention

This invention relates most broadly to the field of arc discharge lamps and more specifically to alkali-gas high-pressure arc discharge lamps.

2. Description of Prior Art

Near-infrared night-vision systems often employ light sources to provide increased viewing range or additional lighting when the ambient light levels are too low. The most common sources are: gallium arsenide devices such as lasers and light emitting diodes, tungsten-halogen lamps, and xenon discharge lamps. The later two sources can be filtered to remove visible light from the beam in order to provide covert surveillance.

The three light sources discussed above suffer from significant disadvantages. Gallium arsenide devices are efficient but costly at high power levels. In addition, the lasers with coherent output near 0.9 nm present the possibility of unintended retinal damage. The lamps generate substantial incoherent light, and while eye-safe and less costly, suffer from poor efficiency in the near-infrared. Most of the light energy generated by the lamps is visible (not used). In the case of the xenon lamp significant energy is also lost to ultraviolet emissions (also not used.) Xe high-pressure short arc lamps are preferred over tungsten lamps when eye-safety is an issue due to their high brightness (radiant exitance), which allows the formation, with optics, of well collimated beams. There are currently two manufacturers of xenon short arc lamp systems for night-vision known to us, Xenonics (Carlsbad, Calif.) and Peakbeam (Edgemont, Pa.). The low efficiency of the lamps leads to large (heavy) batteries and limited lamp life due to high temperature operation and reactive plasma constituents. Clearly, a high-efficiency, eye-safe, high brightness, near-infrared lamp for night-vision applications is desirable.

The alkali elements L (lithium), Na (sodium), K (potassium), Rb (rubidium), and Cs (cesium) have certain properties that make them ideal candidates for night-vision discharge-lamps. Among these properties are: 1) low ionization potentials, 2) strong resonance transitions at reasonably long wavelengths, 3) very high double ionization potentials, 4) high vapor pressures at modest temperatures, 5) and low reactivity with certain practically significant dielectrics and metals.

High pressure Cs and Rb short-arc lamps were investigated for night-vision applications in the mid 1960s (H. S. Strauss et al, “Compact arc near infra-red radiation sources,” DITECH report # AD 821794 (1971)) and more recently by Peakbeam Corporation (private communication with W. Mcmanus CEO (2004)). In addition, K & C Technologies Inc. has conducted pulsed plasma experiments with low temperature cells with attached sapphire windows. To date, all experiments indicate that the alkali plasma will bloom radially out from the center-line between the cathode and anode and, although emitting copius near-IR radiation, the lamps will not have high brightness, especially at the cathode tip.

### OBJECTS AND ADVANTAGES

The alkali lamps described here for application as night-vision illuminators, by virtue of the physical properties of alkalis and selected lamp materials, will emit substantially more power into the near-infrared than either the xenon discharge or the tungsten halide lamps operated at the same electrical input power level. In addition, the lamps will operate with high radiant exitance. The advantages are that near-infrared illumination systems using alkali lamps will operate at lower temperatures with less power consumption and longer lamp life at any desired light level than systems using xenon or tungsten lamps.

### SUMMARY OF THE INVENTION

The night-vision illuminator lamp is a hermetically sealed system comprised of a transparent dielectric container. Two metal electrodes in hermetic contact with the container are provided to allow electric current to pass from one electrode to the other through the dielectric container. The container is partially filled with an alkali mixture, and an inert gas, e.g., xenon. The alkali mixture may also be present in an easily dissociated mixture of high vapor pressure alkali salts. When voltage is applied to the electrodes the inert gas breaks down and current begins to flow causing the lamp to heat and the alkali metal or salt mixture to vaporize. Alternatively or in addition to the inert gas, an external pre-heater would provide enough alkali vapor pressure for lamp discharge ignition. The alkali vapor is ionized by electron impact and singly ionized alkali atoms become the dominant ionic species in the discharge. Due to the physical properties of the alkalis listed above the visible emissions from the lamp are suppressed in favor of near IR emissions as will be described in detail below. The proper selection of electrode materials inhibits the arc from blooming and the brightest radiance is located at the cathode tip.

### BRIEF DESCRIPTION OF THE DRAWINGS

These and other objects, features and advantages of the invention will be more readily apparent from the following detailed descriptions of the specific embodiments and physical characteristics of the invention.

FIG. 1 is a schematic illustration of a high-pressure alkali lamp with metal fill tube suitable for both crystalline dielectric and glass transparent envelopes.

FIG. 2 is a schematic illustration of a high-pressure alkali lamp with glass fill tube suitable primarily for glass transparent envelopes.

FIG. 3 is a schematic illustration of the configuration of the electrodes.

FIG. 4 is a schematic illustration of the cesium molecular energy levels with important discharge processes indicated.

### DETAILED DESCRIPTION

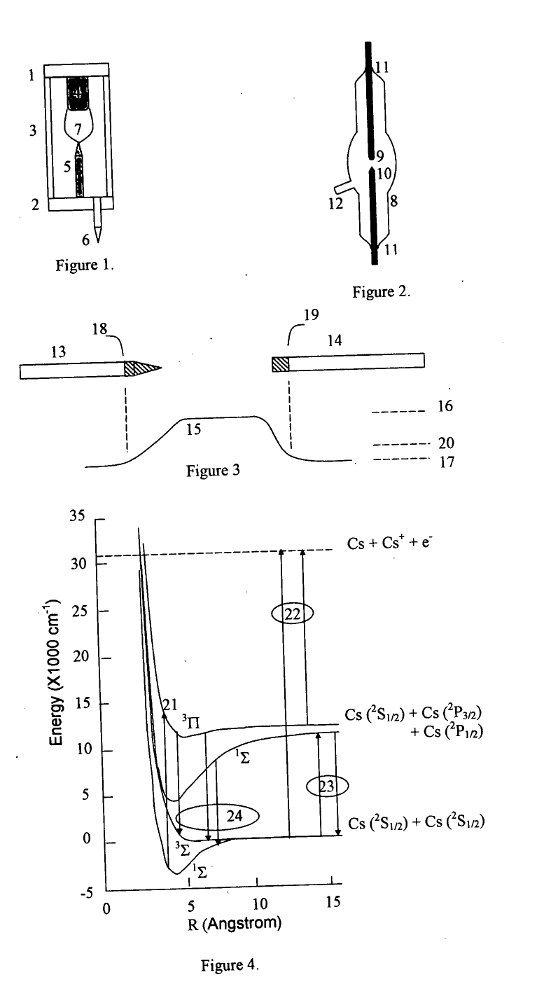

FIG. 1. is a cross-sectional view of a first embodiment of the alkali discharge lamp for night-vision illuminators. Metal end caps 1 and 2 providing electrical contacts are brazed, welded or sealed by an intermediate wetting agent, e.g. a glass frit to the transparent dielectric cylinder 3. The edges of the cylinder may be sintered with a metal so that brazing or welding is made possible. This is an available technology and reports of brazing or welding techniques to CVD diamond and sapphire are readily available. For example, Ceramic Seals Unlimited, Oldham, Britain offers high temperature sapphire to nickel-iron hermetic seals. Also alkali vapor compatible glass-to-metal systems are well known and provide alternative hermetic sealing techniques, e.g., GE-180 aluminosilicate to molybdenum seals. These glasses have been used to fabricate low pressure sodium lamps but not considered for the high pressure sodium arc. The later is usually an arc constricted by the transparent envelope and thus the glasses would melt in operation. However, in a high pressure and unconstricted arc the temperature in the gas falls off rapidly to levels below the melting point of these glasses (˜1000° C.). These glasses are thus suitable for high-pressure arc lamps. Welded to or otherwise electrically connected to the end caps are discharge electrodes 4 (anode), and 5 (cathode). The electrode (particularly the cathode) should be fabricated from a high-temperature metal or metal-ceramic with a work function below the ionization potential of alkali atoms used in the cell. Tungsten carbide (WC) is an attractive metal ceramic electrode candidate. A fill tube 6 is welded to end cap 2 to provide a pump out port and a fill port for alkali or salt mixture and an inert gas, if needed, for discharge start-up and arc stabilization. After filling the lamp, the fill tube is crimp welded to hermetically seal the system. When in operation, the discharge fills the region 7 with radiant plasma. Current and voltage are controlled to provide optimal pressure (determined by the lowest temperature point inside the sealed vessel) and to maintain a typical high-pressure gaseous arc discharge, wherein the predominant species are ground state atoms and to a lesser extent atomic ions and electrons.

A second embodiment depicted in FIG. 2. Behaves similarly in operation to the first embodiment. This embodiment is different in that it is specifically related to alkali resistant glasses such as GE 180. The electrode material is chosen as in the first embodiment to have a work function below the ionization potentials of the alkali mixture as in the first embodiment. The lamp is comprised of a sealed cylinder of alkali resistant glass 8 hermetically sealed to anode 9 and cathode 10 at feed-throughs 11. A glass fill tube 12 provides a method for adding alkali and inert gas. The recognition that alkali resistant glasses are candidates for high pressure short arc discharge lamps is a significant aspect of this invention. Previous work has always used sapphire or fine-grained alumina to confine the gas.

Cs, Rb, and K have ionization potentials of 3.9, 4.2, and 4.4 eV respectively. Each will be ionized when boiled off (atom surface collision) a hot tungsten surface (W work function=4.5 eV). One or more of these alkalis are considered constituents of an optimized near-infrared lamp. It is well known that in the high-pressure arc (from ˜20 Torr to several atmospheres) the electrode surfaces in nearest proximity to the positive column are at extremely high temperatures. Therefore previous work with tungsten electrodes produced in every case a large population of positive ions at the electrode-plasma interface. This is particularly problematic at the cathode, which is the source of electrons for maintenance of the discharge. Positive ion production changes the geometrical character of the discharge forcing it to bloom out radially reducing substantially the arc radiant exitance. FIG. 3 shows in detail the electrode configuration for both embodiments of this invention. The cathode 13 and anode 14 are shown with an exaggerated separation between them. A temperature profile 15 shows the temperature along the axis of the lamp. The temperature is somewhat constant 16 in the arc positive column. The temperature drops along the electrodes from the above mentioned hot surfaces to the ambient internal gas temperature 17 over a short distance. As the temperature drops along the electrode length, the alkalis will partially condense, reducing the surface work function and at some distances 18, 19 from the electrode tips characterized by a specific temperature 20 positive ion production ceases to affect the discharge geometry. The solution to the problem of high positive ion production and a significant feature of this invention is to use a low work function material depicted as cross-hatch in FIG. 3 at the ends of the electrodes nearest the arc column. This material may be deposited on a high work function material as a coating or it may be a solid electrode. This material extends from the hot surfaces to points 18 and 19 or beyond. Certain low work function and electrically conductive metal ceramics withstand high temperatures. WC, with work function 3.6 eV and boiling point of ˜6000° C. is a likely candidate. High temperature materials with low work functions are also candidates, such as the lanthanide and actinide metals. However, the later are radioactive and therefore the least desirable of the three groups. The alkali arc with this electrode material change has the geometrical characteristics common to other high-pressure arc systems, e.g., xenon short-arc lamps.

Cs will be used in the following discussion as representative of each element in the alkali group. A simplified and approximate energy level diagram for the Cs₂ diatomic molecule and Cs atom is shown in FIG. 2. The partial plasma is composed of atoms, atomic ions, and free electrons. Since the energy level structure of a singly ionized alkali atom is similar to a noble gas atom with an extra proton, it has a very high ionization potential. Therefore, only singly ionized atoms are substantially present. Molecular species play a role in the plasma kinetics but in general do not accumulate due to electron impact dissociation 21. Direct electron impact ionization processes 22 pump energy into the discharge.

The energy pumped into the discharge leaves mainly by photo-emission and to a lesser extent as waste heat (conduction, convection). De-excitation of the ions is by various ion-electron recombination channels. Ion-electron recombination is a three-body process and favors either the direct emission of a photon or the formation of a short lived excited state molecule subsequent to a ion, electron, atom collision. The former process leads to various emission continua, but at pressures of interest the later process dominates the de-excitation. The aggregate effect of all the de-excitation reaction channels for the excited state molecules is to produce at least one (often two) first excited state atom (P state) per recombination event. These P state atoms may then radiate to the ground state and the de-excitation cycle is complete.

The majority species in the discharge is ground state atoms. A substantial population of first excited state atoms builds due to radiation trapping. In the trapping process a radiated photon is absorbed by a nearby ground state atom, re-radiated, reabsorbed and so forth 23. The effective lifetime of the first excited state (²P) in a rarefied alkali gas is on the order of 10 nanoseconds, while at pressures of a few Torr and above is effectively lengthened to milliseconds or longer. Trapping channels the radiative de-excitation of the P state atoms to molecular satellite bands 24 which exhibit broad near-infrared continua on the long wavelength side of the resonance line. A substantial fraction of the energy radiated by the discharge is therefore emitted in these continua. Thus the alkali discharge lamp is an ideal near-infrared source for night-vision illuminators.

Similar energy level diagrams and kinetic considerations represent molecules and plasmas composed of two different alkali atoms as would be present in an alkali mixture. The ratio of the mixture may be varied to enhance the radiation in a particular near-infrared spectral band. Only one alkali present represents one extreme of the mixture ratio.

We claim:

1. An alkali discharge lamp for near-infrared illumination systems comprising:
A transparent dielectric container;
Two metal electrodes hermetically sealed to the dielectric container;
An alkali mixture or alkali salt mixture incorporated inside the dielectric container to provide a gaseous atomic alkali mixture in the discharge region;
Said electrodes, either one or both, composed of material with work function below the ionization potential of said atomic alkalis;
said material to extend at least from electrode surface nearest the discharge to a point wherein the alkali positive ion production on atom electrode surface collision is insignificant with respect to the discharge geometry.

2. An alkali discharge lamp as in claim 1 wherein said material is a metal ceramic.

3. An alkali discharge lamp as in claim 2 wherein said metal ceramic is tungsten carbide.

4. An alkali discharge lamp as in claim 1 wherein said material is a lanthanide metal.

5. An alkali discharge lamp as in claim 1 wherein said dielectric is an alkali tolerant glass.

6. An alkali discharge lamp as in claim 5 wherein said alkali tolerant glass is aluminosilicate glass.
